(19) United States
(12) Patent Application Publication
(10) Pub. No.: US 2023/0291913 A1
(43) Pub. Date: Sep. 14, 2023

(54) METHODS, SYSTEMS, AND APPARATUSES FOR IMPROVED ADAPTATION LOGIC AND CONTENT STREAMING

(71) Applicant: Comcast Cable Communications, LLC, Philadelphia, PA (US)

(72) Inventors: Ali C. Begen, Konya (TR); Dan Grois, Beer-Sheva (IL); Alexander Giladi, Denver, CO (US); Yasser Syed, Philadelphia, PA (US)

(21) Appl. No.: 17/694,059

(22) Filed: Mar. 14, 2022

(51) Int. Cl. H04N 19/172; H04N 19/105; H04N 19/59; H04N 21/238

(52) U.S. Cl. CPC H04N 19/172; H04N 19/105; H04N 19/59; H04N 21/238

(57) ABSTRACT

Methods, systems, and apparatuses for improved adaptation logic and content streaming are described herein. Adaptation logic may allow a client device to request differing representations of content based on at least one service metric related to requesting and/or outputting the content. The client device may receive an indication when at least one frame of the content is encoded using an adaptive resolution change. The client device may determine the at least one service metric based on the indication.

### BACKGROUND

Content may be available for client devices at a variety of representations—each having a different resolution and/or bitrate. The client devices may periodically determine a service metric(s) as content is being received and output. Encoders may employ certain encoding techniques when encoding particular frames of a given representation of the content, which may result in those particular frames being smaller or larger in size than expected based on the given representation. When those particular frames are used as a basis for determining the service metric(s), the client devices may inadvertently switch to an alternative representation of the content—or they may fail to so do when circumstances warrant such a switch. These and other considerations are discussed herein.

### SUMMARY

It is to be understood that both the following general description and the following detailed description are exemplary and explanatory only and are not restrictive. Methods, systems, and apparatuses for improved adaptation logic and content streaming are described herein. A client device (e.g., a user device) may use rate adaptation logic (“adaptation logic”) to determine at least one service metric related to content that is being streamed (e.g., requested and/or output). The adaptation logic may allow the client device to request an alternative representation of the content (e.g., a differing resolution and/or bitrate) when the at least one service metric indicates that a current representation of the content being streamed has too high or too low of a resolution and/or bitrate. Some frames of the content may be encoded using content-aware encoding techniques, such as adaptive resolution changes (ARC) and/or reference picture resampling (RPR). Such frames of the content may not be suitable for determining the at least one service metric.

The client device may receive an indication that at least one frame of the content was encoded using ARC and/or RPR. Based on the indication, the client device may perform one or more actions. As an example, based on the indication, the client device may exclude the at least one frame when determining (e.g., calculating) the at least one service metric. As another example, based on the indication, the client device may determine a bandwidth metric. The bandwidth metric may be based on, as an example, a download rate associated with the at least one frame (or a chunk comprising the at least one frame). The bandwidth metric may account for an idle time preceding and/or an idle time following the client device downloading the at least one frame (or the chunk). The client device may take the bandwidth metric into account when determining the at least one service metric.

This summary is not intended to identify critical or essential features of the disclosure, but merely to summarize certain features and variations thereof. Other details and features will be described in the sections that follow.

### BRIEF DESCRIPTION OF THE DRAWINGS

The accompanying drawings, which are incorporated in and constitute a part of this specification, together with the description, serve to explain the principles of the present methods and systems:

FIG. 1 shows an example system;

FIGS. 2A-2E show example content streams;

FIGS. 3A and 3B show example content streams;

FIG. 4 shows an example content stream;

FIG. 5 shows an example content stream

FIG. 6 shows an example system;

FIG. 7 shows a flowchart for an example method;

FIG. 8 shows a flowchart for an example method; and

FIG. 9 shows a flowchart for an example method.

### DETAILED DESCRIPTION

As used in the specification and the appended claims, the singular forms “a,” “an,” and “the” include plural referents unless the context clearly dictates otherwise. Ranges may be expressed herein as from “about” one particular value, and/or to “about” another particular value. When such a range is expressed, another configuration includes from the one particular value and/or to the other particular value. When values are expressed as approximations, by use of the antecedent “about,” it will be understood that the particular value forms another configuration. It will be further understood that the endpoints of each of the ranges are significant both in relation to the other endpoint, and independently of the other endpoint.

“Optional” or “optionally” means that the subsequently described event or circumstance may or may not occur, and that the description includes cases where said event or circumstance occurs and cases where it does not.

Throughout the description and claims of this specification, the word “comprise” and variations of the word, such as “comprising” and “comprises,” means “including but not limited to,” and is not intended to exclude other components, integers, or steps. “Exemplary” means “an example of” and is not intended to convey an indication of a preferred or ideal configuration. “Such as” is not used in a restrictive sense, but for explanatory purposes.

It is understood that when combinations, subsets, interactions, groups, etc. of components are described that, while specific reference of each various individual and collective combinations and permutations of these may not be explicitly described, each is specifically contemplated and described herein. This applies to all parts of this application including, but not limited to, steps in described methods. Thus, if there are a variety of additional steps that may be performed it is understood that each of these additional steps may be performed with any specific configuration or combination of configurations of the described methods.

As will be appreciated by one skilled in the art, hardware, software, or a combination of software and hardware may be implemented. Furthermore, a computer program product on a computer-readable storage medium (e.g., non-transitory) having processor-executable instructions (e.g., computer software) embodied in the storage medium. Any suitable computer-readable storage medium may be utilized including hard disks, CD-ROMs, optical storage devices, magnetic storage devices, memresistors, Non-Volatile Random Access Memory (NVRAM), flash memory, or a combination thereof.

Throughout this application, reference is made to block diagrams and flowcharts. It will be understood that each block of the block diagrams and flowcharts, and combinations of blocks in the block diagrams and flowcharts, respectively, may be implemented by processor-executable instructions. These processor-executable instructions may be loaded onto a general-purpose computer, special purpose computer, or other programmable data processing apparatus to produce a machine, such that the processor-executable instructions which execute on the computer or other programmable data processing apparatus create a device for implementing the functions specified in the flowchart block or blocks.

These processor-executable instructions may also be stored in a computer-readable memory that may direct a computer or other programmable data processing apparatus to function in a particular manner, such that the processor-executable instructions stored in the computer-readable memory produce an article of manufacture including processor-executable instructions for implementing the function specified in the flowchart block or blocks. The processor-executable instructions may also be loaded onto a computer or other programmable data processing apparatus to cause a series of operational steps to be performed on the computer or other programmable apparatus to produce a computer-implemented process such that the processor-executable instructions that execute on the computer or other programmable apparatus provide steps for implementing the functions specified in the flowchart block or blocks.

Accordingly, blocks of the block diagrams and flowcharts support combinations of devices for performing the specified functions, combinations of steps for performing the specified functions and program instruction means for performing the specified functions. It will also be understood that each block of the block diagrams and flowcharts, and combinations of blocks in the block diagrams and flowcharts, may be implemented by special purpose hardware-based computer systems that perform the specified functions or steps, or combinations of special purpose hardware and computer instructions.

“Content items,” as the phrase is used herein, may also be referred to as “content,” “content data,” “content information,” “content asset,” “multimedia asset data file,” or simply “data” or “information”. Content items may be any information or data that may be licensed to one or more individuals (or other entities, such as business or group). Content may be electronic representations of video, audio, text, and/or graphics, which may be but is not limited to electronic representations of videos, movies, or other multimedia, which may be but is not limited to data files adhering to H.264/MPEG-AVC, H.265/MPEG-HEVC, H.266/MPEG-VVC, MPEG-5 EVC, MPEG-5 LCEVC, AV1, MPEG2, MPEG, MPEG4 UHD, SDR, HDR, 4k, Adobe® Flash® Video (.FLV), ITU-T H.261, ITU-T H.262 (MPEG-2 video), ITU-T H.263, ITU-T H.264 (MPEG-4 AVC), ITU-T H.265 (MPEG HEVC), ITU-T H.266 (MPEG VVC) or some other video file format, whether such format is presently known or developed in the future. The content items described herein may be electronic representations of music, spoken words, or other audio, which may be but is not limited to data files adhering to MPEG-1 audio, MPEG-2 audio, MPEG-2 and MPEG-4 advanced audio coding, MPEG-H, AC-3 (Dolby Digital), E-AC-3 (Dolby Digital Plus), AC-4, Dolby Atmos®, DTS®, and/or any other format configured to store electronic audio, whether such format is presently known or developed in the future. Content items may be any combination of the above-described formats.

“Consuming content” or the “consumption of content,” as those phrases are used herein, may also be referred to as “accessing” content, “providing” content, “viewing” content, “listening” to content, “rendering” content, or “playing” content, among other things. In some cases, the particular term utilized may be dependent on the context in which it is used. Consuming video may also be referred to as viewing or playing the video. Consuming audio may also be referred to as listening to or playing the audio. This detailed description may refer to a given entity performing some action. It should be understood that this language may in some cases mean that a system (e.g., a computer) owned and/or controlled by the given entity is actually performing the action.

Provided herein are methods, systems, and apparatuses for improved adaptation logic and content streaming. Adaptive streaming techniques may structure a stream of content as a multi-dimensional array of content pieces (e.g., fragments, segments, chunks, etc.). Each piece of content may represent a temporal slice (e.g., 2-10 seconds in duration), which may be encoded to produce a variety of representations of the content—each having a differing level of quality, resolution, bitrate, etc. Further, each representation may have a different size and therefore require a different amount of bandwidth for delivery to client devices in a timely manner.

The adaptive streaming techniques may comprise content-aware encoding techniques. For example, the content-aware encoding techniques may be used to encode one or more frames of content for one or more representations. The content-aware encoding techniques may comprise, as an example, adaptive resolution changes, reference picture resampling, etc. As a result, bitrates for representations that are encoded using content-aware encoding techniques may vary throughout, which may require client devices to accommodate for bitrate spikes and dives within such representations during streaming sessions.

As an example, a client device (e.g., a user device) may use the adaptation logic described herein to determine at least one service metric related to content that is being streamed (e.g., requested and/or output). The at least one service metric may be a quality of service measurement, a quality of experience measurement, a bandwidth measurement, a combination thereof, and/or the like. The adaptation logic may allow the client device to request an alternative representation of the content (e.g., a differing resolution and/or bitrate) when the at least one service metric indicates that a current representation of the content being streamed has too high or too low of a resolution and/or bitrate.

As discussed herein, one or more frames of the content may be encoded using content-aware encoding techniques, such as adaptive resolution changes, reference picture resampling, etc. Such frames of the content may not be suitable for determining the at least one service metric. The client device may receive an indication that a first frame of the content was encoded using content-aware encoding techniques. The indication may be within a portion of a manifest associated with the content. The first frame and/or a frame that precedes the first frame may be indicative of the indication. The client device may receive a message comprising the indication. A metadata track associated with the content may comprise the indication. A segment boundary and/or a chunk indicator boundary may comprise the indication. Other examples are possible as well.

Based on the indication, the client device may perform one or more actions. As an example, based on the indication, the client device may exclude the first frame when determining (e.g., calculating) the at least one service metric. As another example, based on the indication, the client device may determine a bandwidth metric. The bandwidth metric may be based on, as an example, a download rate associated with the first frame (or a chunk comprising the first frame). The bandwidth metric may account for an idle time preceding and/or an idle time following the client device downloading the first frame (or the chunk). Other examples for determining the bandwidth metric are possible as well. The client device may take the bandwidth metric into account when determining the at least one service metric. The client device may determine whether to request an alternative representation of the content based on the at least one service metric.

The client device may receive a second indication associated with a further frame of the content. The second indication may indicate that the further frame was not encoded using the content-aware encoding techniques. The second indication may be within a portion of the manifest. The further frame and/or a frame that precedes the further frame may be indicative of the second indication. The client device may receive a message comprising the second indication. The metadata track associated with the content may comprise the second indication. A segment boundary and/or a chunk indicator boundary may comprise the second indication. Other examples are possible as well.

The further frame may comprise a transform coefficient, a quantization value, a motion estimation value, an inter-prediction value, an intra-prediction value, a partitioning value, a combination thereof, and/or the like. The client device may determine the at least one service metric based on the second indication and the further frame. As discussed herein, the client device may determine whether to request an alternative representation of the content based on the at least one service metric.

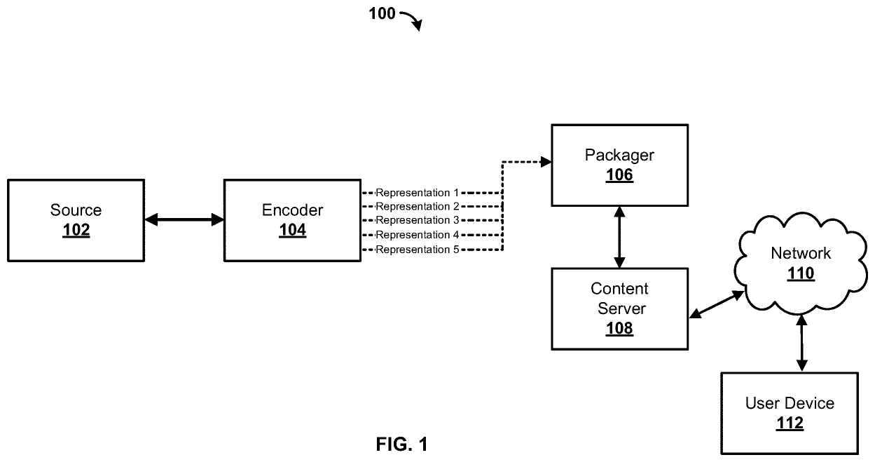

FIG. 1 shows an example system 100 for improved adaptation logic and content streaming. The system 100 may comprise a plurality of computing devices/entities in communication via a network 110. The network 110 may be an optical fiber network, a coaxial cable network, a hybrid fiber-coaxial network, a wireless network, a satellite system, a direct broadcast system, an Ethernet network, a high-definition multimedia interface network, a Universal Serial Bus (USB) network, or any combination thereof. Data may be sent on the network 110 via a variety of transmission paths, including wireless paths (e.g., satellite paths, Wi-Fi paths, cellular paths, etc.) and terrestrial paths (e.g., wired paths, a direct feed source via a direct line, etc.). The network 110 may comprise public networks, private networks, wide area networks (e.g., Internet), local area networks, and/or the like. The network 110 may comprise a content access network, content distribution network, and/or the like. The network 110 may be configured to provide content from a variety of sources using a variety of network paths, protocols, devices, and/or the like. The content delivery network and/or content access network may be managed (e.g., deployed, serviced) by a content provider, a service provider, and/or the like. The network 110 may deliver content items from a source(s) to a user device(s).

The system 100 may comprise a source 102, such as a server or other computing device. The source 102 may receive source streams for a plurality of content items. The source streams may be live streams (e.g., a linear content stream) and/or video-on-demand (VOD) streams. The live streams may comprise, for example, low-latency (“LL”) live streams. The source 102 may receive the source streams from an external server or device (e.g., a stream capture source, a data storage device, a media server, etc.). The source 102 may receive the source streams via a wired or wireless network connection, such as the network 110 or another network (not shown).

The source 102 may comprise a headend, a video-on-demand server, a cable modem termination system, and/or the like. The source 102 may provide content (e.g., video, audio, games, applications, data) and/or content items (e.g., video, streaming content, movies, shows/programs, etc.) to user devices. The source 102 may provide streaming media, such as live content, on-demand content (e.g., video-on-demand), content recordings, and/or the like. The source 102 may be managed by third-party content providers, service providers, online content providers, over-the-top content providers, and/or the like. A content item may be provided via a subscription, by individual item purchase or rental, and/or the like. The source 102 may be configured to provide content items via the network 110. Content items may be accessed by user devices via applications, such as mobile applications, television applications, set-top box applications, gaming device applications, and/or the like. An application may be a custom application (e.g., by a content provider, for a specific device), a general content browser (e.g., a web browser), an electronic program guide, and/or the like.

The source 102 may provide uncompressed content items, such as raw video data, comprising one or more portions (e.g., frames/slices, groups of pictures (GOP), coding units (CU), coding tree units (CTU), etc.). It should be noted that although a single source 102 is shown in FIG. 1, this is not to be considered limiting. In accordance with the described techniques, the system 100 may comprise a plurality of sources 102, each of which may receive any number of source streams.

The system 100 may comprise an encoder 104, such as a video encoder, a content encoder, etc. The encoder 104 may be configured to encode one or more source streams (e.g., received via the source 102) into a plurality of content items/streams at various bitrates (e.g., various representations). For example, the encoder 104 may be configured to encode a source stream for a content item at varying bitrates for corresponding representations (e.g., versions) of a content item for adaptive bitrate streaming. As shown in FIG. 1, the encoder 104 may encode a source stream into Representations 1-5. It is to be understood that the FIG. 1 shows five representations for explanation purposes only. The encoder 104 may be configured to encode a source stream into fewer or greater representations. Representation 1 may be associated with a first resolution (e.g., 480p) and/or a first bitrate (e.g., 4 Mbps). Representation 2 may be associated with a second resolution (e.g., 720p) and/or a second bitrate (e.g., 5 Mbps). Representation 3 may be associated with a third resolution (e.g., 1080p) and/or a third bitrate (e.g., 6 Mbps). Representation 4 may be associated with a fourth resolution (e.g., 4K) and/or a first bitrate (e.g., 10 Mbps). Representation 5 may be associated with a fifth resolution (e.g., 8K) and/or a fifth bitrate (e.g., 15 Mbps). Other examples resolutions and/or bitrates are possible.

The encoder 104 may be configured to determine one or more encoding parameters. The encoding parameters may be based on one or more content streams encoded by the encoder 104. For example, an encoding parameter may comprise at least one of an encoding quantization level (e.g., a size of coefficient range for grouping coefficients), a predictive frame error, a relative size of an inter-coded frame with respect to an intra-coded frame, a number of motion vectors to encode in a frame, a quantizing step size (e.g., a bit precision), a combination thereof, and/or the like. As another example, an encoding parameter may comprise a value indicating at least one of a low complexity to encode, a medium complexity to encode, or a high complexity to encode. As a further example, an encoding parameter may comprise a transform coefficient(s); a quantization parameter value(s); a motion vector(s); an inter-prediction parameter value(s); an intra-prediction parameter value(s); a motion estimation parameter value(s); a partitioning parameter value(s); a combination thereof, and/or the like. The encoder 104 may be configured to insert encoding parameters into the content streams and/or provide encoding parameters to other devices within the system 100.

Encoding a content stream/item may comprise the encoder 104 partitioning a portion and/or frame of the content stream/item into a plurality of coding tree units (CTUs). Each of the CTUs may comprise a plurality of pixels. The CTUs may be partitioned into coding units (CUs) (e.g., coding blocks). For example, a content item may include a plurality of frames (e.g., a series of frames/pictures/portions, etc.). The plurality of frames may comprise I-frames, P-frames, and/or B-frames. An I-frame (e.g., an Intra-coded picture) may include and/or represent a complete image/picture. A P-frame (e.g., a Predicted picture/delta frame) may comprise only the changes in an image from a previous frame. For example, in a scene where a person moves across a stationary background, only the person's movements need to be encoded in a corresponding P-frame in order to indicate the change in the person's position with respect to the stationary background. To save space and computational resources, the encoder 104 may not store information/data indicating any unchanged background pixels in the P-frame. A B-frame (e.g., a Bidirectional predicted picture) may enable the encoder 104 to save more space and computational resources by storing differences between a current frame and both a preceding and a following frame. A frame may serve as a reference for another frame(s) when one or more encoding parameters associated with the particular frame are used (e.g., referenced by) the other frame(s) during the encoding process. As further described herein, B-frames may serve as reference frames for other B-frames. P-frames may serve as reference frames for other P-frames and/or B-frames. I-frames may serve as reference frames for other B-frames and/or P-frames.

Each frame of a content item may be divided into a quantity of partitions. Each partition may comprise a plurality of pixels. Depending on a coding format (e.g., a CODEC), the partition may be a block, a macroblock, a CTU, etc. The order in which I-frames, P-frames, and B-frames are arranged is referred to herein as a Group of Pictures (GOP) structure—or simply a GOP. The encoder 104 may encode frames as open GOPs or as closed GOPs.

While the description herein refers to the encoder 104 encoding entire frames of content, it is to be understood that the functionality of the encoder 104 may equally apply to a portion of a frame rather than an entire frame. A portion of a frame, as described herein, may comprise one or more coding tree units/blocks (CTUs), one or more coding units/blocks (CUs), a combination thereof, and/or the like. For example, the encoder 104 may allocate a time budget for encoding at least a portion of each frame of a content item. When the 104 encoder takes longer than the allocated time budget to encode at least a portion of a given frame(s) of the content item at a first resolution (e.g., for Representation 5), the encoder 104 may begin to encode frames of the content item—or portions thereof—at a second resolution (e.g., a lower resolution/bitrate, such as Representations 1-4) in order to allow the encoder 104 to “catch up.” As another example, when the encoder 104 takes longer than the allocated time budget to encode at least a portion of at least one frame for the first representation of the content item at the first resolution, the encoder 104 may use content-aware encoding techniques when encoding further frames—or portions thereof—for the first representation. The content-aware encoding techniques may comprise, as an example, adaptive resolution changes, reference picture resampling, etc. The encoder 104 may use the content-aware encoding techniques to “reuse” encoding decisions for corresponding frames that were previously encoded for the second representation at the second resolution.

The system 100 may comprise a packager 106. The packager 106 may be configured to receive one or more content items/streams from the encoder 104. The packager 106 may be configured to prepare content items/streams for distribution. For example, the packager 106 may be configured to convert encoded content items/streams into a plurality of content fragments. The packager 106 may be configured to provide content items/streams according to adaptive bitrate streaming. For example, the packager 106 may be configured to convert encoded content items/streams at various representations into one or more adaptive bitrate streaming formats, such as Apple HTTP Live Streaming (HLS), Microsoft Smooth Streaming, Adobe HTTP Dynamic Streaming (HDS), MPEG DASH, and/or the like. The packager 106 may pre-package content items/streams and/or provide packaging in real-time as content items/streams are requested by user devices, such as a user device 112. The user device 112 may be a content/media player, a set-top box, a client device, a smart device, a mobile device, a user device, etc.

The system 100 may comprise a content server 108. For example, the content server 108 may be configured to receive requests for content, such as content items/streams. The content server 108 may identify a location of a requested content item and provide the content item—or a portion thereof—to a device requesting the content, such as the user device 112. The content server 108 may comprise a Hypertext Transfer Protocol (HTTP) Origin server. The content server 108 may be configured to provide a communication session with a requesting device, such as the user device 112, based on HTTP, FTP, or other protocols. The content server 108 may be one of a plurality of content server distributed across the system 100. The content server 108 may be located in a region proximate to the user device 112. A request for a content stream/item from the user device 112 may be directed to the content server 108 (e.g., due to the location and/or network conditions). The content server 108 may be configured to deliver content streams/items to the user device 112 in a specific format requested by the user device 112. The content server 108 may be configured to provide the user device 112 with a manifest file (e.g., or other index file describing portions of the content) corresponding to a content stream/item. The content server 108 may be configured to provide streaming content (e.g., unicast, multicast) to the user device 112. The content server 108 may be configured to provide a file transfer and/or the like to the user device 112. The content server 108 may cache or otherwise store content (e.g., frequently requested content) to enable faster delivery of content items to users.

The content server 108 may receive a request for a content item, such as a request for high-resolution video and/or the like. The content server 108 may receive request for the content item from the user device 112. As further described herein, the content server 108 may be capable of sending (e.g., to the user device 112) one or more portions of the content item at varying bitrates (e.g., representations 1-5). For example, the user device 112 (or another device of the system 100) may request that the content server 108 send Representation 1 based on a first set of network conditions (e.g., lower-levels of bandwidth, throughput, etc.). As another example, the user device 112 (or another device of the system 100) may request that the content server 108 send Representation 5 based on a second set of network conditions (e.g., higher-levels of bandwidth, throughput, etc.). The content server 108 may receive encoded/packaged portions of the requested content item from the encoder 104 and/or the packager 106 and send (e.g., provide, serve, transmit, etc.) the encoded/packaged portions of the requested content item to the user device 112.

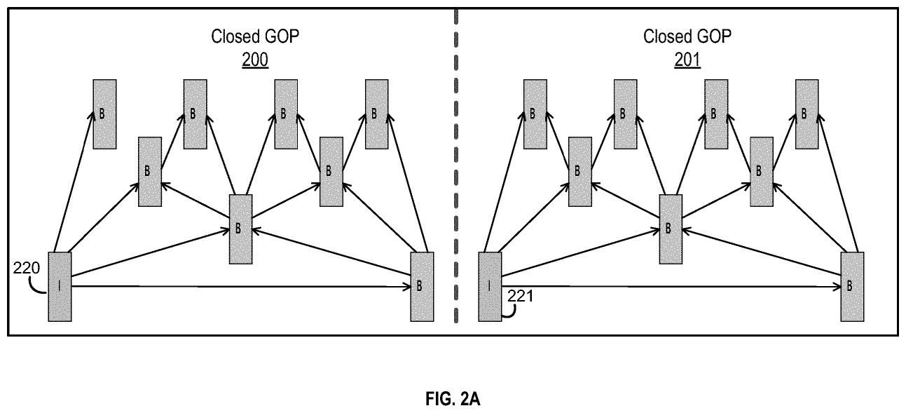

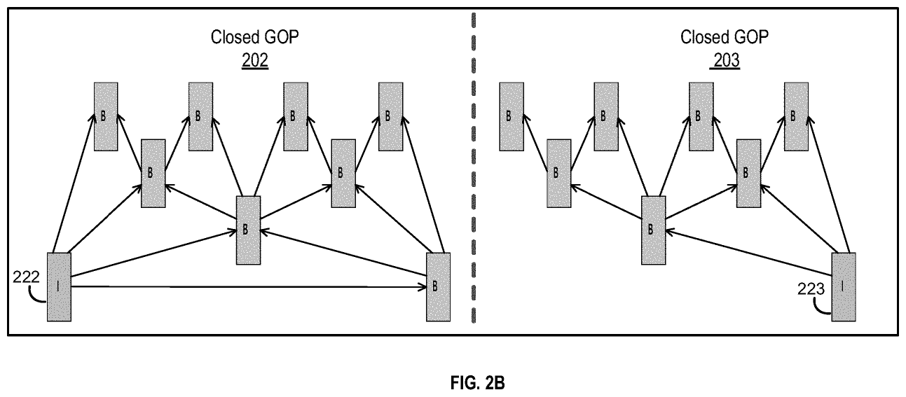

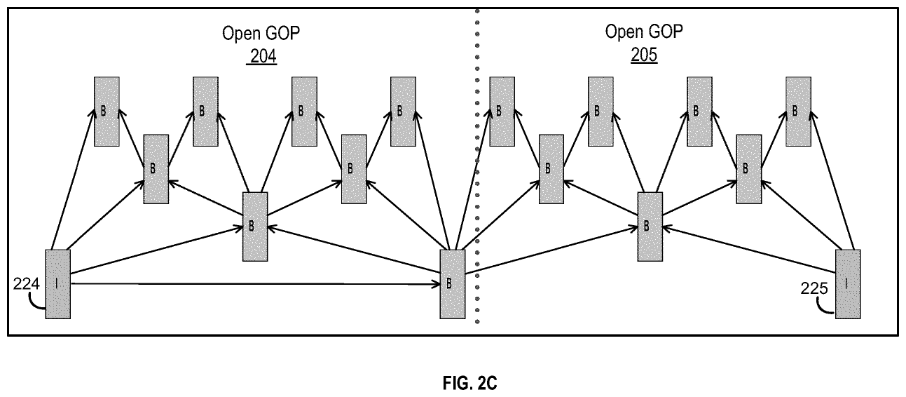

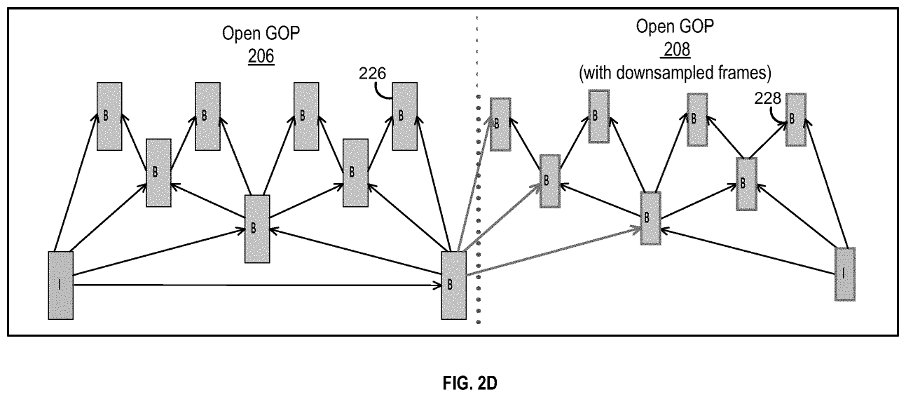

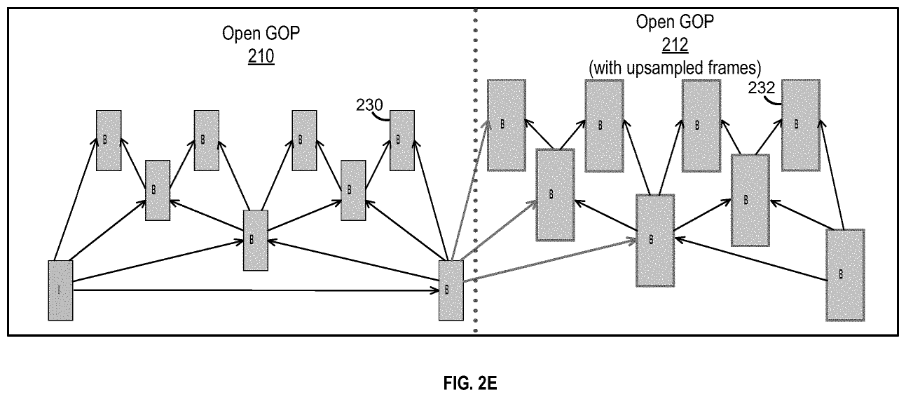

As described herein, the encoder 104 may encode frames of content (e.g., a content item(s)) as open GOPs or as closed GOPs. For example, an open GOP may include B-frames that refer to an I-frame(s) or a P-frame(s) in an adjacent GOP. A closed GOP, for example, may comprise a self-contained GOP that does not rely on frames outside that GOP. FIGS. 2A-2E show examples of GOPs that the encoder 104 may generate when encoding frames of content. While the example GOPs shown in FIGS. 2A-2E depict only I-frames and B-frames, it is to be understood that these example GOPs may include P-frames as well as B-frames. FIGS. 2A-2E depict only I-frames and B-frames for ease of explanation only.

FIG. 2A shows an example GOP 200 of a content stream. The GOP 200 may be a closed GOP. The encoder may generate the GOP 200 when encoding content items according to HEVC, H.264/MPEG-AVC, and/or any other coding standard that does not permit frame referencing between separate GOPs (e.g., frames in the GOP 200 may not reference frames outside of the GOP 200). As shown in FIG. 2A, the GOP 200 and a GOP 201 (schematically separated by a dashed line) may be coded independently by the encoder 104. For example, I-frames 220 and 221 of the GOP 200 and the GOP 201, respectively, may be encoded as Instantaneous Decoding Refresh (IDR) pictures. The I-frames 220 and 221 may each be a reference frame for each of a plurality of respective B-frames. For example, each B-frame of a plurality of B-frames of the GOP 200 may use (e.g., reference) one or more encoding parameters associated with the I-frame 220. Similarly, each B-frame of a plurality of B-frames of the GOP 201 may use (e.g., reference) one or more encoding parameters associated with the I-frame 221.

FIG. 2B shows an example GOP 202 and an example GOP 203. The GOPs 202 and 203 may be closed GOPs. The encoder 104 may generate the GOPs 202 and 203 based on any coding standard that permits frame referencing within a GOP but does not permit frame referencing between separate GOPs. The GOP 203 may not start with an I-frame (e.g., in contrast to the GOPs 201 and 202), thereby leading to a higher compression gain. As shown in FIG. 2B, an I-frame 223 in the GOP 203 may be the last frame in the display order of the GOP 203, while the I-frame 223 may be, for example, the first frame in a coding order of the GOP 203, thereby resulting in a more efficient coding structure and higher compression gain. Similar to FIG. 2A, an I-frame 222 and the I-frame 223 may each be encoded as IDR pictures that each serves as a reference frame for corresponding B-frames in each GOP (e.g., B-frames in the GOP 202 may reference the I-frame 222 and B-frames in the GOP 203 may reference the I-frame 223).

FIG. 2C shows example GOPs 204 and 205, each of which may be an open GOP. For example, the encoder 104 may encode each of the GOPs 204 and 205 using any coding standard that permits open GOPs and referencing frames between separate GOPs. As shown in FIG. 2C, one or more B-frames in the GOP 204 may be a reference frame for one or more B-frames in the GOP 205. Thus, the GOP 204 may comprise one or more B-frames that are used as reference frames by one or more frames of the GOP 205, or vice-versa. For example, the B-frames in the GOP 204 may refer to motion information and/or other encoding parameters/decisions of one or more frames in the GOP 205, or vice-versa, thereby reducing an overall size of the B-frames. As shown in FIG. 2C, an I-frame 224 of the GOP 204 may be encoded as an IDR picture that may be used as a reference frame for each of a plurality of the B-frames in the GOP 204, and an I-frame 225 of the GOP 205 may be encoded as an IDR picture that may be used as a reference frame for each of a plurality of the B-frames in the GOP 205. In other words, the plurality of the B-frames in the GOP 204 may refer to motion information and/or other encoding parameters/decisions of the I-frame 224, and the plurality of the B-frames in the GOP 205 may refer to motion information and/or other encoding parameters/decisions of the I-frame 225.

The encoder 104 may vary a bitrate and/or a resolution of encoded content by downsampling and/or upsampling one or more portions of the content. For example, when downsampling, the encoder 104 may lower a sampling rate and/or sample size (e.g., a number of bits per sample) of the content. The encoder 104 may downsample content to decrease an overall bitrate when sending encoded portions of the content to the content server 108 and or the user device 110. The encoder 104 may downsample, for example, due to limited bandwidth and/or other network/hardware resources. An increase in available bandwidth and/or other network/hardware resources may cause the encoder 104 to upsample one or more portions of the content. For example, when upsampling, the encoder 104 may use the VVC coding standard, which permits reference frames (e.g., reference pictures, such B-frames) from a first representation to be resampled (e.g., used as a reference) when encoding another representation. The processes required when downsampling and upsampling by the encoder 104 may be referred to as content-aware encoding techniques as described herein (e.g., adaptive resolution changes, reference picture resampling, etc.).

FIG. 2D show example GOPs the encoder 104 may generate according to the content-aware encoding techniques as described herein. FIG. 2D shows an example of downsampling an open GOP using content-aware encoding techniques. For example, as shown in FIG. 2D, a B-frame of an open GOP 206 may be used as a reference frame for a plurality of B-frames of an open GOP 208 that are downsampled to a lower resolution. The downsampling is represented in FIG. 2E by the decrease in size in the reference frames (B-frames) in the open GOP 208. For example, B-frame 228 of the open GOP 208 is smaller in size than B-frame 226 of the open GOP 206.

FIG. 2E shows an example of upsampling an open GOP using content-aware encoding techniques. For example, as shown in FIG. 2E, a B-frame of an open GOP 210 may be used as a reference frame for a plurality of B-frames of an open GOP 212 that are upsampled to a higher resolution. The upsampling is represented by the increase in size in the reference frames (B-frames) in the open GOP 212 as compared to the reference frames in the open GOP 210. For example, B-frame 232 of the open GOP 212 is larger than B-frame 230 of the open GOP 212.

Some encoding standards, such as the VVC codec (e.g., H.266), permit enhanced content-aware encoding techniques referred to herein interchangeably as adaptive resolution change (“ARC”) and/or reference picture resampling (“RPR”). For example, the encoder 104 may utilize ARC to upsample and/or downsample reference pictures in a GOP “on the fly” to improve coding efficiency based on current network conditions and/or hardware conditions/resources. The content-aware encoding techniques described herein may be especially beneficial for videoconferencing tools, which require a consistently stable connection due to the latency requirements. The encoder 104 may downsample for various reasons. For example, the encoder 104 may downsample when the source 102 is no longer able to provide a source stream of the content at a requested resolution (e.g., a requested representation). As another example, the encoder 104 may downsample when network bandwidth is no longer sufficient to timely send content at a requested resolution (e.g., a requested representation) to the user device 112. As another example, the encoder 104 may downsample when a requested resolution (e.g., a requested representation) is not supported by a requesting device (e.g., the user device 112). Further, as discussed herein, the encoder 104 may downsample when the 104 encoder takes longer than an allocated time budget to encode at least a portion of a given frame(s) of requested content item at a requested resolution (e.g., a requested representation).

The encoder 104 may upsample for various reasons. For example, the encoder 104 may upsample when the source 102 becomes able to provide a source stream of the content at a higher resolution (e.g., a representation with a higher bitrate than currently being output). As another example, the encoder 104 may upsample when network bandwidth permits the encoder 104 to timely send content at a higher resolution to the user device 112. As another example, the encoder 104 may upsample when a higher is supported by a requesting device (e.g., the user device 112).

The user device 112 may use adaptation logic as described herein to determine at least one service metric related to content that is being streamed (e.g., requested and/or output). The at least one service metric may be a quality of service (QoS) measurement, a quality of experience (QoE) measurement, a bandwidth measurement (e.g., a throughput measurement), a combination thereof, and/or the like. The adaptation logic may allow the user device 112 to request an alternative representation of the content (e.g., a differing resolution and/or bitrate) when the at least one service metric indicates that a current representation of the content being streamed has too high or too low of a resolution and/or bitrate.

When the user device 112 requests content that only has only one available representation, the user device 112 may not need to be aware of upsampling and/or downsampling performed by the encoder 104, because the user device 112 in that scenario cannot “choose” to switch to another representation. In contrast, in multi-stream applications (e.g., using simulcast) and/or low-latency live streaming systems (e.g., DASH-LL and/or LL-HLS) for content, there may be multiple streams/representations of the content from which the user device 112 may choose when requesting the content. To enable the user device 112 to accurately and effectively determine the at least one service metric, the system 100 may be configured to “inform” the user device 112 of upsampling and/or downsampling performed by the encoder 104 when the encoder 104 utilizes the content-aware encoding techniques described herein.

In low-latency live streaming, DASH-LL and/or LL-HLS may be used by the system 100 for streaming content. For example, the encoder 104 may generate Common Media Application Format (CMAF) segments and/or CMAF chunks relating to the content. The CMAF segments may comprise sequences of one or more consecutive fragments from a track of the content, while the CMAF chunks may comprise sequential subsets of media samples from a particular fragment. The encoder 104 may encode 6-second (or any other quantity of time) CMAF segments and 0.5-second (or any other quantity of time) CMAF chunks. The user device 112 may send requests for CMAF segments of the content every 6 seconds, and the content server 108 may send each CMAF segment chunk-by-chunk using, for example, HTTP's chunked transfer encoding method. The CMAF segments may each comprise a GOP that starts with an IDR frame (e.g., I-frame) to allow bitrate switching at segment boundaries, since the user device 112 may be configured to determine whether to request an alternative representation of the content at the segment boundaries.

Continuing with the above example, and referring to FIG. 1, the content may be encoded by the encoder 104 into Representations 1-5. Representation 1 may be associated with a first resolution (e.g., 480p) and/or a first bitrate (e.g., 4 Mbps). Representation 2 may be associated with a second resolution (e.g., 720p) and/or a second bitrate (e.g., 5 Mbps). Representation 3 may be associated with a third resolution (e.g., 1080p) and/or a third bitrate (e.g., 6 Mbps). Representation 4 may be associated with a fourth resolution (e.g., 4K) and/or a first bitrate (e.g., 10 Mbps). Representation 5 may be associated with a fifth resolution (e.g., 8K) and/or a fifth bitrate (e.g., 15 Mbps).

For purposes of explanation, assume for example that Representations 5, 3, 2, and 1 are not encoded using ARC/RPR, while Representation 4 may be encoded using ARC/RPR. In such an example, for Representations 5, 3, 2, and 1, the encoder 104 may generate 2-second CMAF fragments (e.g., 3 fragments per segment) of the content, and these fragments may each start with an intra-coded frame (e.g., they may be independently decodable). For Representation 4, which may be encoded using ARC/RPR, the encoder 104 may also generate 2-second CMAF fragments (e.g., 3 fragments per segment) of the content. Representation 4 may be associated with the fourth resolution (e.g., 4K) and/or the fourth bitrate (e.g., 10 Mbps); however, since ARC/RPR is enabled for Representation 4, an overall resolution for Representation 4 may change based on the content and how the encoder 104 upsamples and/or downsamples (e.g., using ARC/RPR). For example, if the encoder 104 determines that Representation 4 may have a better visual quality at a lower resolution (e.g., lower than 4K), the encoder 104 may use a lower resolution (e.g., 1080p). As another example, if the encoder 104 determines that Representation 4 may have a better visual quality at a higher resolution, the encoder 104 switch back to encoding at the fourth resolution (e.g., 4K).

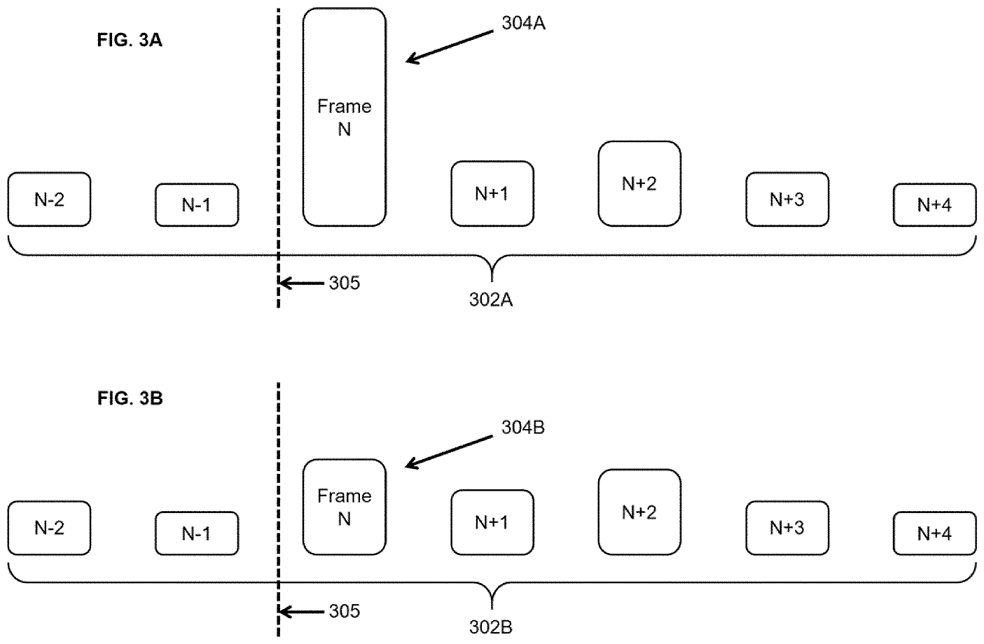

Adaptation logic used by some existing client devices/user devices may not allow such devices to be aware of dynamic resolution changes performed by encoders. As a result, these devices may inaccurately determine service metrics and subsequently request an inappropriate (e.g., less efficient) representation of content. Additionally, many client devices/user devices (or applications executing thereon) may require (or prefer) a particular resolution, and the adaptation logic used by these devices may inhibit the devices in this regard when dynamic resolution changes are performed by an encoder. In contrast to the adaptation logic used by the existing client devices/user devices discussed above, the user device 112 may be configured to use improved adaptation logic such that the user device 112 may take into account dynamic resolution changes performed by the encoder 104 when determining the at least one service metric. This improved adaption logic is further described herein with respect to FIGS. 3-5.

Turning to FIG. 3A, an example content stream 302A is shown. Returning to the example above, assume that Representations 5, 3, 2, and 1 shown in FIG. 1 are not encoded using ARC/RPR, while Representation 4 may be encoded using ARC/RPR. The content stream 302A may represent a plurality of frames of any of Representations 5, 3, 2, and 1, in which resolution changes may require a “large” frame (e.g., an IDR frame/I-frame). For example, the encoder 104 may encode frames N−2 and N−1 of the content stream 302A at a first resolution, and the encoder 104 may then switch to another resolution (e.g., a higher resolution) at a switching point 305. The switching point 305 may represent a boundary between two segments, two fragments, and/or two GOPs (e.g., as shown in FIGS. 2A-2E). A frame 304A (Frame N) of the content stream 302A may follow the switching point 305. The frame 304A may comprise a reference frame, such as an I-frame, that is used as a reference by other frames (e.g., B-frames).

The encoder 104 may determine a plurality of first encoding parameters when encoding the frame 304A. The plurality of first encoding parameters may comprise any of the encoding parameters described herein, such as an encoding quantization level(s); a predictive frame error(s); a relative size(s) of an inter-coded frame(s) with respect to an intra-coded frame(s); a number of motion vectors, a quantizing step size(s); a value indicating an encoding complexity; a transform coefficient(s); a quantization parameter value(s); a motion vector(s); an inter-prediction parameter value(s); an intra-prediction parameter value(s); a motion estimation parameter value(s); a partitioning parameter value(s); a combination thereof, and/or the like. The plurality of first encoding parameters may be associated with as few as one or as many as all of the frames within the content stream 302A. For example, the plurality of first encoding parameters may be associated with the frame 304A and frames N+1-N+4 of the content stream 302A.

The encoder 104 may encode the frame 304A based on the plurality of first encoding parameters. The frame 304A may be indicative of the plurality of first encoding parameters. The user device 112 may receive the content stream 302A. The user device 112 may use the frame 304A when determining the at least one service metric. Since the frame 304A may be indicative of the plurality of first encoding parameters, the user device 112 may determine the at least one service metric based on the plurality of first encoding parameters. The at least one service metric—having the frame 304A as a basis for determination/calculation—may therefore provide the user device 112 with an accurate indication of a quality of service (QoS) measurement, a quality of experience (QoE) measurement, a bandwidth measurement (e.g., a throughput measurement), etc. associated with the content stream 302A and the resolution change designated by the switching point 305. The frame 304A may therefore allow the user device 112 to make an appropriate decision regarding whether an alternative representation of the content (e.g., a differing resolution and/or bitrate) should be requested based on the resulting values of the QoS measurement, the QoE measurement, and/or the bandwidth measurement. For example, the at least one service metric—having the frame 304A as a basis for determination/calculation—may allow the user device 112 to determine that the frames 304A and N+1−N+4 following the switching point 305 comprise a resolution that is too high or too low based on current network and/or hardware conditions. The user device 112 may therefore switch to an alternative representation of the content when the at least one service metric indicates that such a switch is justified. For example, the user device 112 may send a request for the alternative representation (e.g., to the content server 108, the packager 106, the encoder 104, the source 102, etc.).

Turning to FIG. 3B, an example content stream 302B is shown. The content stream 302B may, for example, represent a plurality of frames of Representation 4, which may be encoded by the encoder 104 using ARC/RPR. Therefore, in contrast to the content stream 302A in FIG. 3A, resolution changes in the content stream 302B may not require a “large” frame (e.g., an IDR frame/I-frame) following the switching point 305. For example, the encoder 104 may encode frames N−2 and N−1 of the content stream 302B at the first resolution, and the encoder 104 may then switch to the other resolution (e.g., a higher resolution) at the switching point 305. A frame 304B (Frame N) of the content stream 302B may follow the switching point 305. The frame 304B may comprise a frame that is used as a reference by another frame(s) and/or references another frame(s). For example, the frame 304B may comprise a B-frame that serves as a reference frame for another B-frame(s), and/or the frame 304B may comprise a frame that references another B-frame(s). As another example, the frame 304B may comprise a P-frame that serves as a reference frame for another P-frame(s) or a B-frame(s), and/or the frame 304B may comprise a frame that references another P-frame(s).

The encoder 104 may determine a plurality of second encoding parameters when encoding the frame 304B. The plurality of second encoding parameters may comprise any of the parameters of the first plurality of encoding parameter. The plurality of second encoding parameters may be associated with as few as one or as many as all of the frames within the content stream 302B. For example, the plurality of second encoding parameters may be associated with the frame 304B and frames N+1-N+4 of the content stream 302B. However, as a result of the encoder 104 using ARC/RPR to encode the content stream 302B, and as indicated by the smaller size of the frame 304B as compared to the frame 304A, the values associated with the second plurality of encoding parameters may be smaller and/or different as compared to the plurality of first encoding parameters.

The encoder 104 may encode the frame 304B based on the plurality of second encoding parameters. The frame 304B may be indicative of the plurality of second encoding parameters. The user device 112 may receive the content stream 302B. The user device 112 may use the frame 304B when determining the at least one service metric. Since the frame 304B may be indicative of the plurality of second encoding parameters, the user device 112 may determine the at least one service metric based on the plurality of second encoding parameters. The at least one service metric—having the frame 304B as a basis for determination/calculation—may not provide the user device 112 with as accurate of an indication of a QoS measurement, a QoE measurement, a bandwidth measurement, etc. associated with the content stream 302B and the resolution change as compared to the at least one service metric determined/calculated using the frame 304A as the basis. The frame 304B may therefore cause the user device 112 to make an inappropriate decision regarding whether an alternative representation of the content (e.g., a differing resolution and/or bitrate) should be requested based on the resulting values of the QoS measurement, the QoE measurement, and/or the bandwidth measurement. For example, the at least one service metric—having the frame 304B as the basis for determination/calculation—may cause the user device 112 to incorrectly determine that the frames 304A and N+1-N+4 following the switching point 305 comprise a resolution that is too high or too low based on current network and/or hardware conditions. The user device 112 may therefore switch to an alternative representation of the content based on the incorrect/inaccurate determination/calculation of the at least one service metric when such a switch may not be justified. For example, the at least one service metric—having the frame 304B as the basis for determination/calculation—may cause the user device 112 to determine an inaccurate level of available bandwidth and/or resources, and the user device 112 may send a request for the alternative representation (e.g., to the content server 108, the packager 106, the encoder 104, the source 102, etc.) as a result.

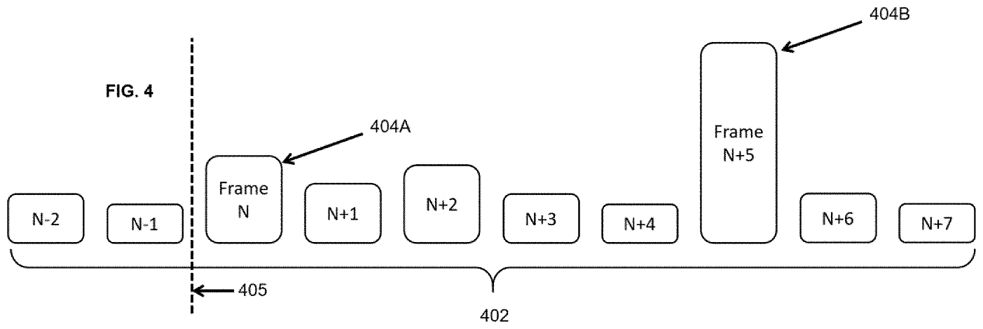

The system 100 may utilize improved adaptation logic to prevent the user device 112 from determining/calculating the at least one service metric using insufficient/inaccurate information, such as the frame 304B. The encoder 104, the packager 106, the content server 108, and/or any other upstream device of the system 100 may indicate to the user device 112 when frames of content are encoded using the content-aware encoding techniques (e.g., ARC/RPR) and when frames of content are not encoded using the content-aware encoding techniques. For example, FIG. 4 shows a content stream 402 that may provide such indications to the user device 112. The content stream 402 may comprise a frame 404A that was encoded using ARC/RPR (e.g., similar to the frame 304B) and a frame 404B that was not encoded using ARC/RPR (e.g., similar to the frame 304A).

The encoder 104, the packager 106, the content server 108, and/or any other upstream device of the system 100 may send the content stream 402 to the user device 112. Any of the aforementioned devices of the system 100 may send a first indication and a second indication to the user device 112. Additionally, or in the alternative, the content stream 402 itself may comprise the first indication and the second indication.

The first indication may be associated with the frame 404A. For example, the first indication may signal to the user device 112 that the frame 404A was encoded using ARC/RPR. The first indication may cause the user device 112 not to use the frame 404A (and/or any encoding parameter(s) associated therewith) when determining/calculating the at least one service metric. The first indication may further cause the user device 112 not to use one or more frames that are adjacent to the frame 404A (and/or any encoding parameter(s) associated therewith) when determining/calculating the at least one service metric. The second indication may be associated with the frame 404B. For example, the second indication may signal to the user device 112 that the frame 404B was not encoded using ARC/RPR. The second indication may cause the user device 112 to use the frame 404B (and/or any encoding parameter(s) associated therewith) when determining/calculating the at least one service metric. The second indication may further cause the user device 112 to use one or more frames that are adjacent to the frame 404B (and/or any encoding parameter(s) associated therewith) when determining/calculating the at least one service metric.

The first indication and the second indication may be part of the improved adaptation logic described herein. While the examples described herein include the first indication and the second indication, it is to be understood that the user device 112 may receive the first indication or the second indication but not both indications. For example, the user device 112 may not receive the second notification. For example, the user device 112 may only be notified when a frame(s) is encoded using ARC/RPR (e.g., via the first indication and/or similar indications); however, the user device 112 may not be notified when a frame(s) is not encoded using ARC/RPR (e.g., via the second indication). In such scenarios/configurations, the user device 112 may assume that the further frame is to be included when determining the at least one service metric. In other words, the user device 112 may default to using any/all frames when determining the at least one service metric, absent an indication/instruction to the contrary (e.g., the first indication and/or a similar indication). In other scenarios/configurations, the user device 112 may not receive the first notification. For example, the user device 112 may only be notified when a frame(s) is not encoded using ARC/RPR (e.g., via the second indication and/or similar indications); however, the user device 112 may not be notified when a frame(s) is encoded using ARC/RPR (e.g., via the first indication). In such scenarios/configurations, the user device 112 may assume that the first frame is not to be included when determining the at least one service metric calculation. In other words, the user device 112 may default to not using any frame when determining the at least one service metric, absent an indication/instruction to the contrary (e.g., the second indication and/or a similar indication).

The improved adaptation logic described herein may enable the user device 112 to determine/calculate the at least one service metric using accurate/representative information, such as any encoding parameters associated with the frame 404B and one or more adjacent frames. The improved adaptation logic may further prevent the user device 112 from determining/calculating the at least one service metric using inaccurate/non-representative information, such as any encoding parameters associated with the frame 404A and one or more adjacent frames.

The first indication and/or the second indication may be sent (e.g., provided, signaled) to the user device 112 in a variety of ways. The first indication and/or the second indication may be within a portion of a manifest (or a manifest update) associated with the content stream 402. The manifest may be a DASH manifest, an HLS manifest, an HDS manifest, etc. The frame 404A and/or a frame that precedes the frame 404A (e.g., frames N−2 or N−1 of the content stream 402) may be indicative of the first indication. The frame 404B and/or a frame that precedes the frame 404B (e.g., any frames N−2-N+4 of the content stream 402) may be indicative of the second indication. The user device 112 may receive a message comprising the first indication and/or the second indication. The message may be any suitable network message, such as an event message, a manifest message, an update message, etc. The message may be sent by any of the devices of the system 100 or any other device in communication with the user device 112. The first indication and/or the second indication may be included within a metadata track associated with the content stream 402. The metadata track may be sent by any of the devices of the system 100 or any other device in communication with the user device 112. The first indication and/or the second indication may be included within a segment boundary and/or a chunk indicator boundary associated with the content stream 402. The segment boundary may be part of a segment of the content stream 402. The segment may be sent to the user device 112 by any of the devices of the system 100 or any other device in communication with the user device 112. The chunk boundary may be part of a chunk of the content stream 402. The chunk may be sent to the user device 112 by any of the devices of the system 100 or any other device in communication with the user device 112. Other examples are possible as well.

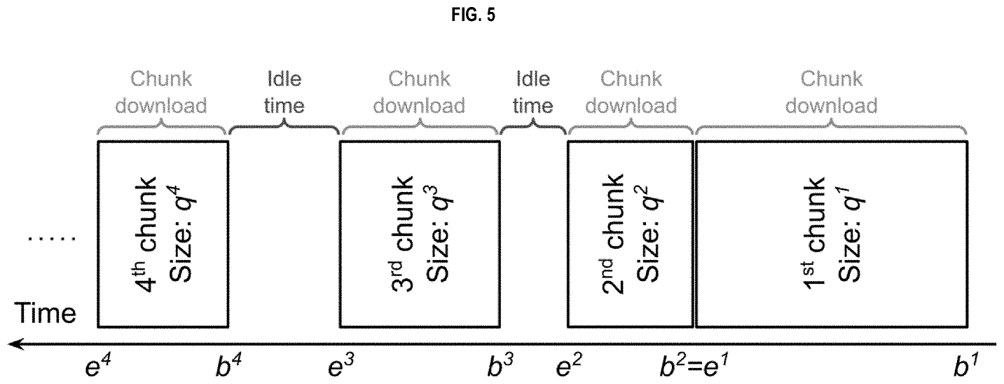

The at least one service metric may take into account encoding parameters associated with frames of content as described herein. The at least one service metric may also consider idle times that are present between receiving chunks of content. Assuming the system 100 comprises a finite amount of network bandwidth, larger chunks of content may take a greater amount of time to be sent from the content server 108 to the user device 112 as compared to smaller chunks of the content. FIG. 5 shows a plurality of chunks of a content stream with respect to time. As shown in FIG. 5, a 1^{st} Chunk may comprise a size q¹, and a 2^{nd} Chunk may comprise a size q² that is smaller than q¹. The 1^{st} Chunk may correspond to a “large” frame (e.g., an IDR frame/I-frame), such as the frame 304A, that was not encoded using ARC/RPR. The 1^{st} Chunk may be received by the user device 112 between times b¹ (e.g., beginning of 1^{st} Chunk) and e¹ (e.g., ending of 1^{st} Chunk). Due to the size q¹ of the 1^{st} Chunk, the user device 112 may receive the 2^{nd} Chunk at time b² (e.g., beginning of 2^{nd} Chunk) that corresponds to time e¹ (e.g., ending of the 1^{st} Chunk). As a result, there may not be any idle time between the user device 112 receiving the 1^{st} Chunk and receiving the 2^{nd} Chunk.

However, as shown in FIG. 5, there may be an idle time between the user device 112 receiving the 2^{nd} Chunk and a 3^{rd} Chunk of the content of a media segment. As also shown in FIG. 5, there may be an idle time between the user device 112 receiving the 3^{rd} Chunk and a 4^{th} Chunk of the content. The size q² of the 2^{nd} Chunk, as well as a size q³ of the 3^{rd} Chunk and a size q⁴ of the 4^{th} Chunk, may be smaller (and more uniformly sized as compared to one another) than the size q¹ of the 1^{st} Chunk. The idle times shown in FIG. 5 may be a result of the size disparities.

The adaptation logic employed by the user device 112 may take such idle times into account when determining/calculating the at least one service metric. For example, the user device 112 may use two or more chunks shown in FIG. 5 to determine a bandwidth metric. The at least one service metric may comprise (or consider) the bandwidth metric. The bandwidth metric may consider the size of a chunk(s) and the time required to access/receive the chunk(s) by the user device 112. The bandwidth metric may be used to determine whether an idle time(s) is indicative of a bandwidth limitation associated with the user device 112 and/or network—in which case the associated chunk(s) should be used when determining the at least one service metric.

As one example, the bandwidth metric may be determined based on an average download rate (e.g., Kbps, Mbps, etc.) for a plurality of chunks within a segment with respect to an average download rate (e.g., Kbps, Mbps, etc.) for each segment. The plurality of chunks may comprise n downloaded chunks (e.g., 2, 3, 4, 5 chunks, etc.), such as the 3 most recently downloaded chunks—although fewer or greater chunks may be considered as well. A download rate for a chunk may be determined by dividing the chunk's size by the chunk's ending time minus an ending time for an adjacent (e.g., previously downloaded) chunk. Other examples for determining the download rate are possible as well (e.g., based on signaling received by the user device 112, a message received by the user device 112, etc.). A download rate for a particular chunk may not be used to determine the bandwidth metric (e.g., it may be disregarded) when the download rate for that chunk is within a threshold range as compared to the average segment download rate. The threshold range may comprise a percentage (e.g., +/−20%), an amount of time (e.g., +/−n seconds), etc. On the other hand, a download rate for a particular chunk may be used to determine the bandwidth metric when the download rate for that chunk is greater than the threshold range as compared to the average segment download rate. Download rates that fall within the threshold range may be disregarded when determining the bandwidth metric, because such download rates may be relatively “close” to the average segment download rate (e.g., in terms of amount of time) due to a corresponding idle time(s) between the chunks, which may be a result of a source limitation (e.g., a transmission limitation associated with a source(s) of the particular chunks is influencing the download rates). Conversely, download rates that fall outside of the threshold range may be considered when determining the bandwidth metric, because corresponding idle times between the chunks may be negligible and such download rates may be a result of network conditions (e.g., such download rates may be influenced by network/bandwidth limitations).

As an example, the plurality of chunks may comprise the three most recently downloaded chunks, such as the 4^{th} Chunk, the 3^{rd} Chunk, and the 2^{nd} Chunk shown in FIG. 5. The user device 112 may receive the 2^{nd} Chunk between times b² and e². The user device 112 may receive the 3^{rd} Chunk between times b³ and e³. And the user device 112 may receive the 4^{th} Chunk between times b⁴ and e⁴. The user device 112 may determine each of the end times e², e³, and e⁴ based on, for example, an application programming interface (API) associated with the content stream 402 and/or the content server 108. As shown in FIG. 5, an idle time exists between the times e² and b³ (e.g., between the 2^{nd} Chunk and the 3^{rd} Chunk) as well as between the times e³ and b⁴ (e.g., between the 3^{rd} Chunk and the 4^{th} Chunk). The user device 112 may determine the bandwidth metric based on an average of the download rates for the 4^{th} Chunk, the 3^{rd} Chunk, and the 2^{nd} Chunk. For example, the download rate for the 4^{th} Chunk may be determined by dividing a size of the 4^{th} Chunk by (e⁴−e³) (e.g., 2 MB/(00:01:03:15-00:01:02:40)). As noted above, the user device 112 may disregard any of the download rates that are within a threshold range as compared to an average segment download rate. For example, the average segment download rate may be n milliseconds, and the download rate for the 4^{th} Chunk may be X Mbps (e.g., 2 MB/(e⁴−e³)). If the download rate for the 4^{th} Chunk is +/−20% of n milliseconds (e.g., if it falls within the threshold range), then the download rate for the 4^{th} Chunk may be disregarded when determining the bandwidth metric and the at least one service metric. Otherwise, the download rate for the 4^{th} Chunk may be considered when determining the bandwidth metric and the at least one service metric.

The user device 112 may, or may not, determine the bandwidth metric described herein based on the first indication and/or the second indication. For example, the first indication, which may signal to the user device 112 that the frame 404A was encoded using ARC/RPR, may cause the user device 112 not to determine the bandwidth metric using a chunk comprising the frame 404A. As another example, the first indication may cause the user device 112 to consider a download rate associated with a chunk(s) that follows the chunk comprising the frame 404A when determining the bandwidth metric if the corresponding download rate(s) for that chunk(s) falls outside of the applicable threshold range. As a further example, the second indication, which may signal to the user device 112 that the frame 404B was not encoded using ARC/RPR, may cause the user device 112 to determine the bandwidth metric using a chunk comprising the frame 404B if the corresponding download rate for that chunk falls outside of the applicable threshold range. The user device 112 may take the applicable bandwidth metric into account when determining the at least one service metric. As a result, because download rates that fall within the threshold range are not considered in the bandwidth metric, the at least one service metric may be more accurate and/or representative of actual network conditions.

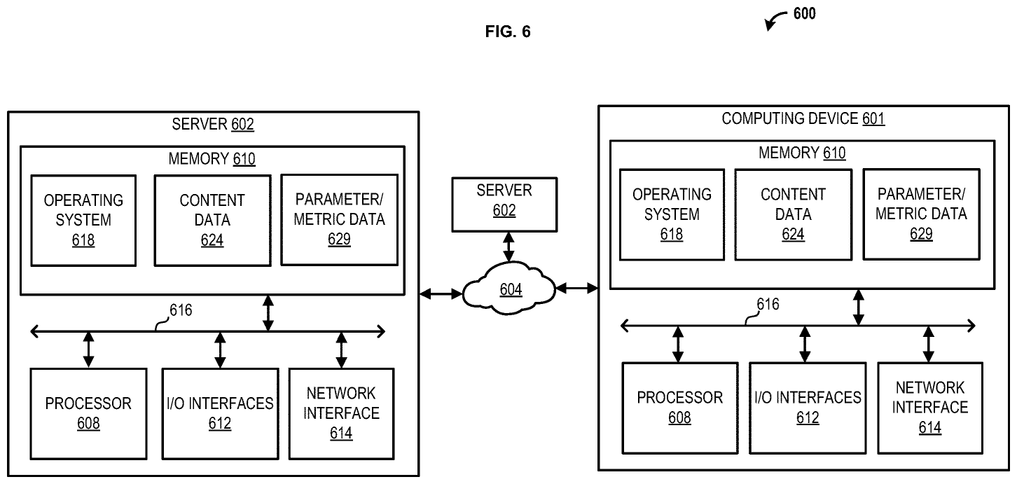

The present methods and systems may be computer-implemented. FIG. 6 shows a block diagram depicting a system/environment 600 comprising non-limiting examples of a computing device 601 and a server 602 connected through a network 604. Either of the computing device 601 or the server 602 may be a computing device, such as any of the devices of the system 100 shown in FIG. 1. In an aspect, some or all steps of any described method may be performed on a computing device as described herein. The computing device 601 may comprise one or multiple computers configured to store parameter/metric data 629 (e.g., relating to the at least one service metric and/or encoding parameters described herein, etc.), and/or the like. The server 602 may comprise one or multiple computers configured to store content data 624 (e.g., a plurality of content segments). Multiple servers 602 may communicate with the computing device 601 via the through the network 604.

The computing device 601 and the server 602 may be a digital computer that, in terms of hardware architecture, generally includes a processor 608, system memory 610, input/output (I/O) interfaces 612, and network interfaces 614. These components (608, 610, 612, and 614) are communicatively coupled via a local interface 616. The local interface 616 may be, for example, but not limited to, one or more buses or other wired or wireless connections, as is known in the art. The local interface 616 may have additional elements, which are omitted for simplicity, such as controllers, buffers (caches), drivers, repeaters, and receivers, to enable communications. Further, the local interface may include address, control, and/or data connections to enable appropriate communications among the aforementioned components.

The processor 608 may be a hardware device for executing software, particularly that stored in system memory 610. The processor 608 may be any custom made or commercially available processor, a central processing unit (CPU), an auxiliary processor among several processors associated with the computing device 601 and the server 602, a semiconductor-based microprocessor (in the form of a microchip or chip set), or generally any device for executing software instructions. When the computing device 601 and/or the server 602 is in operation, the processor 608 may execute software stored within the system memory 610, to communicate data to and from the system memory 610, and to generally control operations of the computing device 601 and the server 602 pursuant to the software.

The I/O interfaces 612 may be used to receive user input from, and/or for providing system output to, one or more devices or components. User input may be provided via, for example, a keyboard and/or a mouse. System output may be provided via a display device and a printer (not shown). I/O interfaces 612 may include, for example, a serial port, a parallel port, a Small Computer System Interface (SCSI), an infrared (IR) interface, a radio frequency (RF) interface, and/or a universal serial bus (USB) interface.

The network interface 614 may be used to transmit and receive from the computing device 601 and/or the server 602 on the network 604. The network interface 614 may include, for example, a 10BaseT Ethernet Adaptor, a 10BaseT Ethernet Adaptor, a LAN PHY Ethernet Adaptor, a Token Ring Adaptor, a wireless network adapter (e.g., WiFi, cellular, satellite), or any other suitable network interface device. The network interface 614 may include address, control, and/or data connections to enable appropriate communications on the network 604.

The system memory 610 may include any one or combination of volatile memory elements (e.g., random access memory (RAM, such as DRAM, SRAM, SDRAM, etc.)) and nonvolatile memory elements (e.g., ROM, hard drive, tape, CDROM, DVDROM, etc.). Moreover, the system memory 610 may incorporate electronic, magnetic, optical, and/or other types of storage media. Note that the system memory 610 may have a distributed architecture, where various components are situated remote from one another, but may be accessed by the processor 608.

The software in system memory 610 may include one or more software programs, each of which comprises an ordered listing of executable instructions for implementing logical functions. In the example of FIG. 6, the software in the system memory 610 of the computing device 601 may comprise the parameter/metric data 629, the content data 624, and a suitable operating system (O/S) 618. In the example of FIG. 6, the software in the system memory 610 of the server 602 may comprise the parameter/metric data 629, the content data 624, and a suitable operating system (O/S) 618. The operating system 618 essentially controls the execution of other computer programs and provides scheduling, input-output control, file and data management, memory management, and communication control and related services.

For purposes of illustration, application programs and other executable program components such as the operating system 618 are shown herein as discrete blocks, although it is recognized that such programs and components may reside at various times in different storage components of the computing device 601 and/or the server 602. An implementation of the system/environment 600 may be stored on or transmitted across some form of computer readable media. Any of the disclosed methods may be performed by computer readable instructions embodied on computer readable media. Computer readable media may be any available media that may be accessed by a computer. By way of example and not meant to be limiting, computer readable media may comprise “computer storage media” and “communications media.” “Computer storage media” may comprise volatile and non-volatile, removable and non-removable media implemented in any methods or technology for storage of information such as computer readable instructions, data structures, program modules, or other data. Exemplary computer storage media may comprise RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which may be used to store the desired information and which may be accessed by a computer.

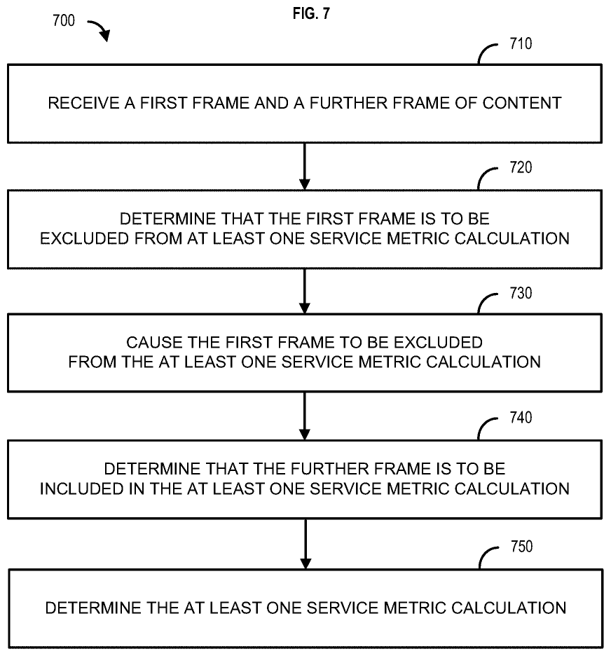

FIG. 7 shows a flowchart of an example method 700 for improved adaptation logic and content streaming. The method 700 may be performed in whole or in part by a single computing device, a plurality of computing devices, and the like. For example, the steps of the method 700 may be performed by the user device 112 shown in FIG. 1 and/or a computing device in communication with the user device 112. Some steps of the method 700 may be performed by a first computing device (e.g., the user device 112), while other steps of the method 700 may be performed by another computing device.

At step 710, the computing device may receive a first frame and a further frame of content. In some examples, the first frame and the further frame may be consecutive frames within a GOP and/or content stream. In other examples, the first frame and the further frame may be not be consecutive frames within a GOP and/or content stream. At step 720, the computing device may determine that the first frame is to be excluded from at least one service metric calculation. For example, the computing device may determine that the first frame is to be excluded from the at least one service metric calculation based on a first indication associated with the first frame. The first indication may identify the first frame as being associated with content-aware encoding techniques, such as adaptive resolution change (ARC) and/or Reference Picture Resampling (RPR) as described herein. That is, the first indication may indicate (e.g., signal) to the computing device that an encoder (e.g., the encoder 104) encoded the first frame using ARC/RPR. The at least one service metric may comprise at least one of: a quality of service measurement, a quality of experience measurement, or a bandwidth measurement.

At step 730, the computing device may cause the first frame to be excluded from the at least one service metric calculation. For example, the computing device may cause the first frame to be excluded from the at least one service metric calculation based on the first indication. At step 740, the computing device may determine that the further frame is to be included in the at least one service metric calculation. For example, the computing device may determine that the further frame is to be included in the at least one service metric calculation based on a further indication associated with the further frame. The further indication may identify the further frame as not being associated with content-aware encoding techniques. That is, the further indication may indicate (e.g., signal) to the computing device that an encoder (e.g., the encoder 104) did not encode the further frame using ARC/RPR.

The first indication and/or the further indication may be sent (e.g., provided, signaled) to the computing device in a variety of ways. The first indication and/or the further indication may be within a portion of a manifest (or a manifest update) associated with the content. The manifest may be a DASH manifest, an HLS manifest, an HDS manifest, etc. The first frame (e.g., the frame 404A) and/or a frame that precedes the first frame (e.g., frames N−2 or N−1 of the content stream 402) may be indicative of the first indication. The further frame (e.g., the frame 404B) and/or a frame that precedes the further frame (e.g., any frames N−2−N+4 of the content stream 402) may be indicative of the further indication. The computing device may receive a message comprising the first indication and/or the further indication. The message may be any suitable network message, such as an event message, a manifest message, an update message, etc. The message may be sent by any device in communication with the computing device. The first indication and/or the further indication may be included within a metadata track associated with the content. The metadata track may be sent by any of the devices in communication with the computing device. The first indication and/or the further indication may be included within a segment boundary and/or a chunk indicator boundary associated with the content. The segment boundary may be part of a segment of a content stream. The segment may be sent to the computing device by any device in communication with the computing device. The chunk boundary may be part of a chunk of the content stream. The chunk may be sent to the computing device by any device in communication with the computing device. Other examples are possible as well.

In some scenarios/configurations of the method 700, the computing device may not receive the further notification. For example, the computing device may only be notified when a frame(s) is encoded using ARC/RPR (e.g., via the first indication and/or similar indications); however, the computing device may not be notified when a frame(s) is not encoded using ARC/RPR (e.g., via the further indication). In such scenarios/configurations, the computing device may assume that the further frame is to be included in the at least one service metric calculation. In other words, the computing device may default to using any/all frames in the at least one service metric calculation, absent an indication/instruction to the contrary (e.g., the first indication and/or a similar indication).

In other scenarios/configurations of the method 700, the computing device may not receive the first notification. For example, the computing device may only be notified when a frame(s) is not encoded using ARC/RPR (e.g., via the further indication and/or similar indications); however, the computing device may not be notified when a frame(s) is encoded using ARC/RPR (e.g., via the first indication). In such scenarios/configurations, the computing device may assume that the first frame is not to be included in the at least one service metric calculation. In other words, the computing device may default to not using any frame in the at least one service metric calculation, absent an indication/instruction to the contrary (e.g., the further indication and/or a similar indication).

At step 750, the computing device may determine/calculate the at least one service metric. For example, the computing device may determine the at least one service metric based on the further indication and/or based on the further frame. The further frame may comprise at least one of: a transform coefficient, a quantization value, a motion estimation value, an inter-prediction value, an intra-prediction value, or a partitioning value.

The computing device may determine a bandwidth metric. The bandwidth metric may consider the size of a portion of the content (e.g., a frame, chunk, etc.) and a time required to access/receive that portion of the content. The bandwidth metric may be used to determine whether an idle time(s) associated with that portion is indicative of a bandwidth limitation associated with the computing device and/or network. The bandwidth metric may be based on a download rate associated with the first frame (or a chunk comprising the first frame) and one or more adjacent frames (or chunks comprising the one or more adjacent frames). For example, the computing device may determine the bandwidth metric based on the first indication. The computing device may take the bandwidth metric into account when determining/calculating the at least one service metric.

The further frame may be associated with a first representation of the content. For example, the encoder may downsample or upsample when encoding the further frame based on the first representation. The computing device may send a request for a second representation of the content that differs from the first representation. For example, the computing device may send the request for the second representation of the content based on the at least one service metric calculation. The computing device may receive a plurality of frames of the second representation of the content. The second representation may be associated with a higher resolution than a resolution associated with the first representation (e.g., when the at least one service metric indicates that a higher resolution/bitrate may be appropriate). As another example, the second representation may be associated with a lower resolution than the resolution associated with the first representation (e.g., when the at least one service metric indicates that a lower resolution/bitrate may be appropriate).

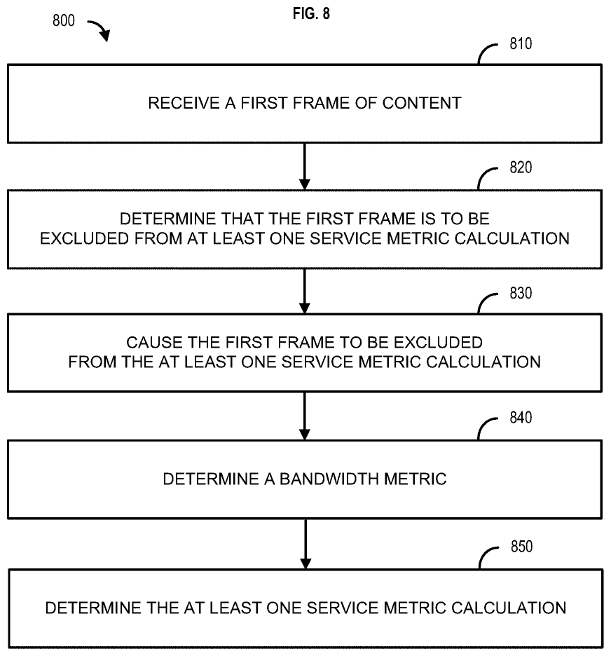

FIG. 8 shows a flowchart of an example method 800 for improved adaptation logic and content streaming. The method 800 may be performed in whole or in part by a single computing device, a plurality of computing devices, and the like. For example, the steps of the method 800 may be performed by the user device 112 shown in FIG. 1 and/or a computing device in communication with the user device 112. Some steps of the method 800 may be performed by a first computing device (e.g., the user device 112), while other steps of the method 800 may be performed by another computing device.

At step 810, the computing device may receive a first frame of content. The first frame may be within a GOP and/or content stream. At step 820, the computing device may determine that the first frame is to be excluded from at least one service metric calculation. For example, the computing device may determine that the first frame is to be excluded from the at least one service metric calculation based on a first indication associated with the first frame. The first indication may identify the first frame as being associated with content-aware encoding techniques, such as adaptive resolution change (ARC) and/or Reference Picture Resampling (RPR) as described herein. That is, the first indication may indicate (e.g., signal) to the computing device that an encoder (e.g., the encoder 104) encoded the first frame using ARC/RPR. The at least one service metric may comprise at least one of: a quality of service measurement, a quality of experience measurement, or a bandwidth measurement.

At step 830, the computing device may cause the first frame to be excluded from the at least one service metric calculation. For example, the computing device may cause the first frame to be excluded from the at least one service metric calculation based on the first indication. The computing device may determine that a further frame of the content is to be included in the at least one service metric calculation. For example, the computing device may determine that the further frame is to be included in the at least one service metric calculation based on a further indication associated with the further frame. The further indication may identify the further frame as not being associated with content-aware encoding techniques. That is, the further indication may indicate (e.g., signal) to the computing device that an encoder (e.g., the encoder 104) did not encode the further frame using ARC/RPR.

The first indication and/or the further indication may be sent (e.g., provided, signaled) to the computing device in a variety of ways. The first indication and/or the further indication may be within a portion of a manifest (or a manifest update) associated with the content. The manifest may be a DASH manifest, an HLS manifest, an HDS manifest, etc. The first frame (e.g., the frame 404A) and/or a frame that precedes the first frame (e.g., frames N−2 or N−1 of the content stream 402) may be indicative of the first indication. The further frame (e.g., the frame 404B) and/or a frame that precedes the further frame (e.g., any frames N−2-N+4 of the content stream 402) may be indicative of the further indication.

The computing device may receive a message comprising the first indication and/or the further indication. The message may be any suitable network message, such as an event message, a manifest message, an update message, etc. The message may be sent by any device in communication with the computing device. The first indication and/or the further indication may be included within a metadata track associated with the content. The metadata track may be sent by any of the devices in communication with the computing device. The first indication and/or the further indication may be included within a segment boundary and/or a chunk indicator boundary associated with the content. The segment boundary may be part of a segment of a content stream. The segment may be sent to the computing device by any device in communication with the computing device. The chunk boundary may be part of a chunk of the content stream. The chunk may be sent to the computing device by any device in communication with the computing device. Other examples are possible as well.

At step 840, the computing device may determine a bandwidth metric. The bandwidth metric may consider a size of a portion of the content (e.g., a frame, chunk, etc.) and a time required to access/receive that portion of the content. The bandwidth metric may be used to determine whether an idle time(s) associated with that portion is indicative of a bandwidth limitation associated with the computing device and/or network. For example, the computing device may determine the bandwidth metric for download rates associated with the first frame (or a chunk comprising the first frame) and/or one or more adjacent frames (or chunks comprising the one or more adjacent frames). For example, the computing device may determine the bandwidth metric based on the first indication. At step 850, the computing device may determine/calculate the at least one service metric. For example, the computing device may determine the at least one service metric based on the first indication and/or the further indication. The first frame and/or the further frame may comprise at least one of: a transform coefficient, a quantization value, a motion estimation value, an inter-prediction value, an intra-prediction value, or a partitioning value. The computing device may take the bandwidth metric into account when determining/calculating the at least one service metric.

The further frame may be associated with a first representation of the content. For example, the encoder may downsample or upsample when encoding the further frame based on the first representation. The computing device may send a request for a second representation of the content that differs from the first representation. For example, the computing device may send the request for the second representation of the content based on the at least one service metric calculation.

The computing device may receive a plurality of frames of the second representation of the content. The second representation may be associated with a higher resolution than a resolution associated with the first representation (e.g., when the at least one service metric indicates that a higher resolution/bitrate may be appropriate). As another example, the second representation may be associated with a lower resolution than the resolution associated with the first representation (e.g., when the at least one service metric indicates that a lower resolution/bitrate may be appropriate).

In some scenarios/configurations of the method 800, the computing device may not receive the further notification. For example, the computing device may only be notified when a frame(s) is encoded using ARC/RPR (e.g., via the first indication and/or similar indications); however, the computing device may not be notified when a frame(s) is not encoded using ARC/RPR (e.g., via the further indication). In such scenarios/configurations, the computing device may assume that the further frame is to be included when calculating/determining the bandwidth metric and/or the at least one service metric. In other words, the computing device may default to using any/all frames when calculating/determining the bandwidth metric and/or the at least one service metric, absent an indication/instruction to the contrary (e.g., the first indication and/or a similar indication).

In other scenarios/configurations of the method 800, the computing device may not receive the first notification. For example, the computing device may only be notified when a frame(s) is not encoded using ARC/RPR (e.g., via the further indication and/or similar indications); however, the computing device may not be notified when a frame(s) is encoded using ARC/RPR (e.g., via the first indication). In such scenarios/configurations, the computing device may assume that the first frame is not to be included when calculating/determining the bandwidth metric and/or the at least one service metric. In other words, the computing device may default to not using any frame when calculating/determining the bandwidth metric and/or the at least one service metric, absent an indication/instruction to the contrary (e.g., the further indication and/or a similar indication).

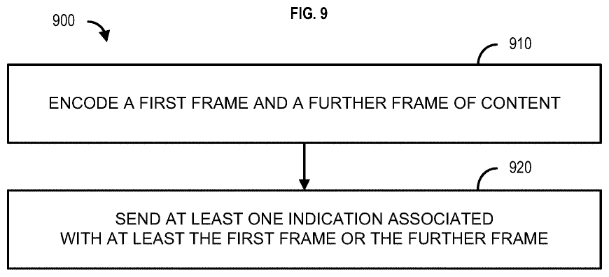

FIG. 9 shows a flowchart of an example method 900 for improved adaptation logic and content streaming. The method 900 may be performed in whole or in part by a single computing device, a plurality of computing devices, and the like. For example, the steps of the method 900 may be performed the encoder 104 shown in FIG. 1 and/or a computing device in communication with the encoder 104. Some steps of the method 900 may be performed by a first computing device (e.g., the encoder 104), while other steps of the method 900 may be performed by another computing device.

The computing device may be configured to encode frames of a content item at multiple resolutions simultaneously. For example, the computing device may encode a source stream for the content item at varying bitrates for corresponding representations (e.g., versions) of the content item for adaptive bitrate streaming (e.g., Representations 1-5 shown in FIG. 1). A first representation and/or a first bitrate. A second representation may be associated with a second resolution and/or a second bitrate. The computing device may encode the content item for additional representations, however, for purposes of explanation, the method 900 will describe two representations. The encoded frames for each representation may be stored as a single binary (e.g., within a single storage file/structure).

The computing device may determine at least one encoding parameter. The at least one encoding parameter may be an encoding decision(s) for a first frame—or a portion thereof—of a plurality of frames of the content item. The plurality of frames may comprise a group of pictures (GOP) structure. The encoding decision may be associated with encoding at least a portion of the first frame for the first representation at the first resolution.

The at least one encoding parameter may comprise at least one of an encoding quantization level (e.g., a size of coefficient range for grouping coefficients) for the at least one portion of the first frame for the first representation, a predictive frame error for the at least one portion of the first frame for the first representation, a relative size of an inter-coded frame with respect to an intra-coded frame, a number of motion vectors to encode in the at least one portion of the first frame for the first representation, a quantizing step size (e.g., a bit precision) for the at least one portion of the first frame for the first representation, a combination thereof, and/or the like. As another example, the at least one encoding parameter may comprise a value indicating at least one of a low complexity to encode, a medium complexity to encode, or a high complexity to encode. As a further example, the at least one encoding parameter may comprise a transform coefficient(s) for the at least one portion of the first frame for the first representation; a quantization parameter value(s) for the at least one portion of the first frame for the first representation; a motion vector(s) for the at least one portion of the first frame for the first representation; an inter-prediction parameter value(s) for the at least one portion of the first frame for the first representation; an intra-prediction parameter value(s) for the at least one portion of the first frame for the first representation; a motion estimation parameter value(s) for the at least one portion of first frame for the first representation, a partitioning parameter value(s) for the at least one portion of the first frame for the first representation; a combination thereof, and/or the like. The computing device may determine at least one encoding parameter for a further frame of the content item in a similar manner.

At step 910, the computing device may encode the first frame and the further frame. For example, the computing device may encode the first frame and the further frame based on the corresponding encoding parameters. The first representation and/or the first bitrate may be associated with a lower resolution and/or lower bitrate as compared to the second representation and/or the second bitrate, respectively. The computing device may use content-aware encoding techniques at step 910 when encoding the first frame. For example, the computing device may use ARC/RPR at step 910 when encoding the first frame. The computing device may not use content-aware encoding techniques at step 910 when encoding the further frame. The computing device may send the first frame and the further frame to a second computing device, such as the user device 112.

At step 920, the computing device may send at least one indication associated with at least the first frame or the further frame. For example, the computing device may send a first indication associated with the first frame and a further indication associated with the further frame. The first indication and the further indication may be sent to the second computing device. The second computing device may receive the first frame and the further frame. The second computing device may receive the first indication and the further indication. The first indication may identify the first frame as being associated with content-aware encoding techniques, such as adaptive resolution change (ARC) and/or Reference Picture Resampling (RPR) as described herein. That is, the first indication may indicate (e.g., signal) to the second computing device that the computing device (e.g., the encoder 104) encoded the first frame using ARC/RPR. The further indication may identify the further frame as not being associated with content-aware encoding techniques. That is, the further indication may indicate (e.g., signal) to the second computing device that the computing device (e.g., the encoder 104) did not encode the further frame using ARC/RPR.

The second computing device may determine that the first frame is to be excluded from at least one service metric calculation. For example, the second computing device may determine that the first frame is to be excluded from the at least one service metric calculation based on the first indication associated with the first frame. The at least one service metric may comprise at least one of: a quality of service measurement, a quality of experience measurement, or a bandwidth measurement. The second computing device may cause the first frame to be excluded from the at least one service metric calculation. For example, the second computing device may cause the first frame to be excluded from the at least one service metric calculation based on the first indication. The second computing device may determine that the further frame of the content is to be included in the at least one service metric calculation. For example, the second computing device may determine that the further frame is to be included in the at least one service metric calculation based on the further indication associated with the further frame.

The first indication and/or the further indication may be received by the second computing device in a variety of ways. The first indication and/or the further indication may be within a portion of a manifest (or a manifest update) associated with the content. The manifest may be a DASH manifest, an HLS manifest, an HDS manifest, etc. The first frame (e.g., the frame 404A) and/or a frame that precedes the first frame (e.g., frames N−2 or N−1 of the content stream 402) may be indicative of the first indication. The further frame (e.g., the frame 404B) and/or a frame that precedes the further frame (e.g., any frames N−2−N+4 of the content stream 402) may be indicative of the further indication. The second computing device may receive a message comprising the first indication and/or the further indication. The message may be any suitable network message, such as an event message, a manifest message, an update message, etc. The message may be sent by any device in communication with the second computing device. The first indication and/or the further indication may be included within a metadata track associated with the content. The metadata track may be sent by any of the devices in communication with the second computing device. The first indication and/or the further indication may be included within a segment boundary and/or a chunk indicator boundary associated with the content. The segment boundary may be part of a segment of a content stream. The segment may be sent to the second computing device by any device in communication with the second computing device. The chunk boundary may be part of a chunk of the content stream. The chunk may be sent to the second computing device by any device in communication with the second computing device. Other examples are possible as well.

The second computing device may determine/calculate the at least one service metric. For example, the second computing device may determine the at least one service metric based on the further indication and/or based on the further frame. The further frame may comprise at least one of: a transform coefficient, a quantization value, a motion estimation value, an inter-prediction value, an intra-prediction value, or a partitioning value. The second computing device may determine a bandwidth metric. The bandwidth metric may consider a size of a portion of the content (e.g., a frame, chunk, etc.) and a time required to access/receive that portion of the content. The bandwidth metric may be used to determine whether an idle time(s) associated with that portion is indicative of a bandwidth limitation associated with the computing device and/or network. For example, the bandwidth metric may be based on download rates associated with the first frame (or a chunk comprising the first frame) and one or more adjacent frames (or chunks comprising the one or more adjacent frames). For example, the second computing device may determine the bandwidth metric based on the first indication. The second computing device may take the bandwidth metric into account when determining/calculating the at least one service metric.

The further frame may be associated with a first representation of the content. For example, the computing may downsample or upsample when encoding the further frame based on the first representation. The second computing device may send a request for a second representation of the content that differs from the first representation. For example, the second computing device may send the request for the second representation of the content based on the at least one service metric calculation. The second computing device may receive a plurality of frames of the second representation of the content. The second representation may be associated with a higher resolution than a resolution associated with the first representation (e.g., when the at least one service metric indicates that a higher resolution/bitrate may be appropriate). As another example, the second representation may be associated with a lower resolution than the resolution associated with the first representation (e.g., when the at least one service metric indicates that a lower resolution/bitrate may be appropriate).

In some scenarios/configurations of the method 900, the first computing device may not send the further notification. For example, the second computing device may only be notified when a frame(s) is encoded using ARC/RPR (e.g., via the first indication and/or similar indications); however, the second computing device may not be notified when a frame(s) is not encoded using ARC/RPR (e.g., via the further indication). In such scenarios/configurations, the second computing device may assume that the further frame is to be included when calculating/determining the bandwidth metric and/or the at least one service metric. In other words, the second computing device may default to using any/all frames when calculating/determining the bandwidth metric and/or the at least one service metric, absent an indication/instruction to the contrary (e.g., the first indication and/or a similar indication).

In other scenarios/configurations of the method 900, the first computing device may not send the first notification. For example, the second computing device may only be notified when a frame(s) is not encoded using ARC/RPR (e.g., via the further indication and/or similar indications); however, the second computing device may not be notified when a frame(s) is encoded using ARC/RPR (e.g., via the first indication). In such scenarios/configurations, the second computing device may assume that the first frame is not to be included when calculating/determining the bandwidth metric and/or the at least one service metric. In other words, the second computing device may default to not using any frame when calculating/determining the bandwidth metric and/or the at least one service metric, absent an indication/instruction to the contrary (e.g., the further indication and/or a similar indication).

While specific configurations have been described, it is not intended that the scope be limited to the particular configurations set forth, as the configurations herein are intended in all respects to be possible configurations rather than restrictive. Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that an order be inferred, in any respect. This holds for any possible non-express basis for interpretation, including: matters of logic with respect to arrangement of steps or operational flow; plain meaning derived from grammatical organization or punctuation; the number or type of configurations described in the specification.

It will be apparent to those skilled in the art that various modifications and variations may be made without departing from the scope or spirit. Other configurations will be apparent to those skilled in the art from consideration of the specification and practice described herein. It is intended that the specification and described configurations be considered as exemplary only, with a true scope and spirit being indicated by the following claims.

1. A method comprising:
receiving, at a computing device, a first frame and a further frame of content;
determining, based on a first indication associated with the first frame, that the first frame is to be excluded from at least one service metric calculation;
causing, based on the first indication, the first frame to be excluded from the at least one service metric calculation;
determining, based on a further indication associated with the further frame, that the further frame is to be included in the at least one service metric calculation; and
determining, based on the further indication, and based on the further frame, the at least one service metric calculation.

2. The method of claim 1, wherein the further frame is associated with a first representation of the content, and wherein the method further comprises:
sending, based on the at least one service metric calculation, a request for a second representation of the content; and
receiving a plurality of frames of the second representation of the content.

3. The method of claim 2, wherein the second representation is associated with a higher resolution than a resolution associated with the first representation, or wherein the second representation is associated with a lower resolution than the resolution associated with the first representation.

4. The method of claim 1, wherein the first indication identifies the first frame as being associated with an adaptive resolution change (ARC), and wherein the method further comprises at least one of:
receiving a portion of a manifest associated with the content, wherein the portion of the manifest comprises the first indication;
receiving the first frame, wherein the first frame is indicative of the first indication;
receiving a frame that precedes the first frame, wherein the frame that precedes the first frame is indicative of the first indication;
receiving a message comprising the first indication;
receiving, via a metadata track associated with the content, the first indication;
receiving a segment boundary indicator comprising the first indication; or
receiving a chunk boundary indicator comprising the first indication.

5. The method of claim 1, wherein the second indication identifies the further frame as not being associated with an adaptive resolution change (ARC), and wherein the method further comprises at least one of:
receiving a portion of a manifest associated with the content, wherein the portion of the manifest comprises the second indication;
receiving the further frame, wherein the further frame is indicative of the second indication;
receiving a frame that precedes the further frame, wherein the frame that precedes the further frame is indicative of the second indication;
receiving a message comprising the second indication;
receiving, via a metadata track associated with the content, the second indication;
receiving a segment boundary indicator comprising the second indication; or
receiving a chunk boundary indicator comprising the second indication.

6. The method of claim 1, wherein the at least one service metric calculation comprises at least one of: a quality of service measurement, a quality of experience measurement, or a bandwidth measurement, and wherein the further frame comprises at least one of: a transform coefficient, a quantization value, a motion estimation value, an inter-prediction value, an intra-prediction value, or a partitioning value.

7. The method of claim 1, wherein determining the at least one service metric calculation comprises:
determining, based on the first indication, a bandwidth metric associated with receiving the first frame and one or more frames adjacent to the first frame; and
determining, based on the bandwidth metric, the at least one service metric.

8. A method comprising:
receiving, at a computing device, a first frame of content;
determining, based on a first indication associated with the first frame, that the first frame is to be excluded from at least one service metric calculation;
causing, based on the first indication, the first frame to be excluded from the at least one service metric calculation;
determining, based on the first indication, a bandwidth metric associated with receiving a next frame of the content; and
determining, based on the bandwidth metric, the at least one service metric calculation.

9. The method of claim 8, wherein the first frame comprises a boundary of a first chunk of the content or a first segment of the content.

10. The method of claim 8, wherein the first indication identifies the first frame as being associated with an adaptive resolution change (ARC), and wherein the method further comprises at least one of:
receiving a portion of a manifest associated with the content, wherein the portion of the manifest comprises the first indication;
receiving the first frame, wherein the first frame is indicative of the first indication;
receiving a frame that precedes the first frame, wherein the frame that precedes the first frame is indicative of the first indication;
receiving a message comprising the first indication;
receiving, via a metadata track associated with the content, the first indication;
receiving a segment boundary indicator comprising the first indication; or
receiving a chunk boundary indicator comprising the first indication;

11. The method of claim 8, wherein the at least one service metric calculation comprises at least one of: a quality of service measurement, a quality of experience measurement, or a bandwidth measurement.

12. The method of claim 8, wherein determining the bandwidth metric comprises:
determining, based on the first indication identifying the first frame as being associated with an adaptive resolution change, a download rate associated with the next frame and at least one adjacent frame; and
determining, based on the download rate, and based on a threshold range, the bandwidth metric.

13. The method of claim 8, further comprising:
determining, based on a second indication identifying a further frame of the content as not being associated with an adaptive resolution change, and based on one or more parameters of the further frame, the at least one service metric calculation.

14. The method of claim 13, wherein the one or more parameters of the further frame comprise at least one of: a transform coefficient, a quantization value, a motion estimation value, an inter-prediction value, an intra-prediction value, or a partitioning value.

15. A method comprising:
encoding, by a first computing device, a first frame and a further frame of content, wherein the further frame is associated with a different resolution than a resolution associated with the first frame; and
sending, to a second computing device, at least one indication associated with at least the first frame or the further frame, wherein the at least one indication causes the second computing device to:
exclude the first frame from at least one service metric calculation, and
determine, based on the further frame, the at least one service metric calculation.

16. The method of claim 15, wherein the at least one indication identifies the first frame as being associated with an adaptive resolution change (ARC), and wherein the at least one indication identifies the further frame as not being associated with the ARC.

17. The method of claim 16, wherein sending the at least one indication comprises at least one of:
sending a portion of a manifest associated with the content, wherein the portion of the manifest comprises the at least one indication;
sending the first frame, wherein the first frame is indicative of the at least one indication;
sending a frame that precedes the first frame, wherein the frame that precedes the first frame is indicative of the at least one indication;
sending a message comprising the at least one indication;
sending a metadata track associated with the content, wherein the metadata track comprises the at least one indication;
sending a segment boundary indicator comprising the at least one indication; or
sending a chunk boundary indicator comprising the at least one indication;

18. The method of claim 15, wherein the at least one service metric calculation comprises at least one of: a quality of service measurement, a quality of experience measurement, or a bandwidth measurement.

19. The method of claim 15, wherein the at least one indication further causes the second computing device to:
determine, based on the at least one indication identifying the first frame as being associated with an adaptive resolution change, a bandwidth metric associated with the first frame and at least one adjacent frame; and
determine, based on the bandwidth metric, the at least one service metric calculation.

20. The method of claim 15, wherein the different resolution associated with the further frame comprises a higher resolution than the resolution associated with the first frame, or wherein the different resolution associated with the further frame comprises a lower resolution than the resolution associated with the first frame.
